(19) United States
(12) Patent Application Publication
(10) Pub. No.: US 2011/0041407 A1
(43) Pub. Date: Feb. 24, 2011

(54) LOUVER ROTATING MECHANISM

(75) Inventors: Bart van de Bult, Bergschenhoek (NL); Michiel Jacobus Johannes Langeveld, Zoetermeer (NL); Bryan K. Ruggles, Riverton, UT (US)

Correspondence Address: DORSEY & WHITNEY, LLP;INTELLECTUAL PROPERTY DEPARTMENT, 1400 Wewatta Street, Suite 400, DENVER, CO, 80202-5549, US

(73) Assignee: Hunter Douglas Industries BV, EL Rotterdam (NL)

(21) Appl. No.: 12/867,438

(22) PCT Filed: Feb. 6, 2009
(86) PCT No.: PCT/EP09/00850

§ 371 Date: Nov. 12, 2010

(30) Foreign Application Priority Data
Feb. 15, 2008 (EP) 08002838.4

(51) Int. Cl. E06B 7/086

(52) U.S. Cl. 49/79.1

(57) ABSTRACT

A louver rotating mechanism for louvers of a sectional covering for architectural openings is adapted to rotate the louvers between an open position and a closed position. In the open position, the louvers are in generally parallel planes, and in the closed position, the louvers are generally in a common plane. The rotating mechanism includes a slot and gate system.

The invention relates to a louver rotating mechanism for louvers of a sectional covering for architectural openings. The rotating mechanism thereby is adapted to rotate the louvers between an open position and a closed position. In the open position, the louvers are in generally parallel planes, and in the closed position, the louvers are generally in a common plane.

Such a louver rotating mechanism is known from European patent EP 369068. While this louver rotating mechanism is reasonably efficient in sectional coverings for architectural openings it also relies on the use of ladder cords or cables for the support and movement of the slats. In certain applications and environments there has developed an interest in more sturdy constructional arrangements that can cope with larger architectural openings or those in particularly hostile environments.

Accordingly it is an object of the present invention to propose an improved actuating system for a folding panel assembly that is less susceptible to contamination, but which can still be unobtrusively incorporated in the actuating system. In a more general sense it is thus an object of the invention to overcome or ameliorate at least one of the disadvantages of the prior art. It is also an object of the present invention to provide alternative structures which are less cumbersome in assembly and operation and which moreover can be made relatively inexpensively. Alternatively it is an object of the invention to at least provide the public with a useful choice.

To this end the invention provides a louver rotating mechanism for louvers of a sectional covering for architectural openings, the rotating mechanism being adapted to rotate the louvers between an open position, in which the louvers are in generally parallel planes, and a closed position, in which the louvers are generally in a common plane, wherein the rotating mechanism includes a slot and gate system. Such an arrangement eliminates the need for relatively vulnerable ladder cords for initiating rotational movement of the louvers.

Advantageously the louver rotating system according to the invention can include in its slot and gate system any appropriate combination of: a guiding track; a plurality of louver holders; a slotted flange on the guiding track; a plurality of transverse slots opening into a free edge of the slotted flange; a tilt arm on each of the louver holders; and a gate slider movably associated with the slotted flange to open and close the transverse slots to one or more of the tilt arms.

The louver rotating mechanism may include a guiding track and a plurality of louver holders for holding respective louvers, each louver holder movable along the guiding track and pivotable so as to rotate a respective louver between the open position and the closed position. A mechanism is preferably provided for moving the louver holders along the track between retracted and extended positions. The slot and gate system may include a plurality of slots spaced along the guiding track, each slot extending substantially transversely to the guiding track. Each louver holder may include a respective tilt arm engageable in a respective slot such that movement of each one of the louver holders, when the tilt arm of the one of the louver holders is engaged in a respective slot, causes the one of the louver holders to pivot so as to rotate a respective louver between the open position and the closed position. The slot and gate system may include a gate system for closing the slots so as to prevent tilt arms from engaging in the slots and for opening the slots to allow the tilt arms to engage in the slots.

In this way, the gate system can be considered to include a plurality of respective gates for opening and closing the respective slots.

The gates can be controlled individually or in groups.

Preferably, each respective gate is movable relative to the guiding track between a blocking position in which the respective slot is closed and an access position in which the respective slot is open.

In this way, each slot may be conveniently opened or closed so as to allow a respective tilt arm to engage in that slot and to enable rotation of a respective louver holder.

Although gates may be operated individually, preferably, the gate system includes a gate slider having a plurality of the respective gates for opening and closing respective slots. The gate slider may be movable relative to the guiding track between the blocking position in which the slots are closed and the access position in which the slots are open. In this way, it is only necessary to move the slider in order to open or close simultaneously a plurality of gates and slots.

The gate slider may be movable in the length direction of the guiding track.

With this arrangement, the gate slider may define a plurality of cavities spaced in accordance with the successive transverse slots and movable between the blocking position in which none of the cavities is in register with a transverse slot and the access position in which all of the cavities are in register with a respective transverse slot.

In this way, the gate slider need merely be moved longitudinally with respect to the guiding track in order to open or close the gates.

The gate slider may alternatively be movable transversely to the length of the guiding track.

With this embodiment, the gate slider may include a plurality of gate recesses which confront respective slots, those gate recesses including respective barrier wall portions for blocking access to the respect slots.

The gate system may include a longitudinal slider movable in the length direction of the guiding track. The gate slider is preferably connected to the longitudinal slider such that movement of the longitudinal slider in the length direction of the guiding track is converted into transverse movement of the gate slider.

In this way, it is possible to move the gates between open and closed positions merely by moving the longitudinal slider lengthwise with respect to the guiding track.

Preferably, the gate slider connects with the longitudinal slider by sliding pins which engage in conversion tracks having respective slanted end portions.

The conversion tracks can be formed in the longitudinal slider and the sliding pins formed in the gate slider or the conversion tracks can be formed in the gate slider and the sliding pins formed in the longitudinal slider. Irrespective, by virtue of the slanted portions of the conversion tracks, longitudinal movement of the longitudinal slider is converted into transverse movement of the gate slider so as to open or close the gates/slots.

Preferably, the gate slider is movable transversely between a blocking portion in which the slots are closed an an access portion in which the slots are open.

The gate recesses may include respective transverse recess parts extending behind the respective barrier wall portions. The transverse recess parts are blocked by respective barrier wall portions when the gate recesses are in the blocking position.

The gate recesses may further include respective longitudinal recess parts extending longitudinally from behind respective barrier wall portions. In this way, when the gate slider is in the access position, the respective barrier wall portions are positioned transversely outwardly from the slots so as to expose and provide access to the respective transverse recess parts via the respective longitudinal recess parts.

In this way, with the gate slider in the blocking position, the barrier wall portions overlap with respective slots such that tilt arms are not able to access respective transverse recess parts. However, when the gate slider is moved transversely to the access position, the longitudinal recess parts are also moved transversely outwardly and become available to tilt arms before they reach (as they travel longitudinally) the respective barrier wall portions. In that state, the barrier wall portions are positioned outwardly from the slots such that tilt arms are able to follow the longitudinal recess parts into the transverse recess parts.

The guiding track may include a re-entrant flange defining the transfer slots.

In this way, when the gate slider moves in the length direction of the guiding track, the cavities are moved into or out of alignment with the transverse slots defined by the re-entrant flange. Alternatively, when the gate slider is movable transversely to the length of the guiding track, the barrier wall portions are moved transversely outwardly from under the re-entrant flange so as to expose the transfer slots by means of the longitudinal recess parts.

Rather than use a re-entrant flange defining the transverse slots, it is possible to provide a slot and gate system including a guide wall extending alongside the guiding track with a plurality of spaced apart openings defined in the guide wall. A plurality of respective slider units may be arranged in respective openings and the plurality of transverse slots may be provided in respective slider units.

Preferably, the slider units are movable transversely between a blocking position in which the slots are closed and an access position in which the slots are open.

Each slider unit may include a respective barrier wall portion arranged to block access to a respective opening when the respective slider unit is in the blocking position.

By blocking the respective opening, the respective tilt arms may be prevented from accessing the transverse slots in the slider units.

In this respect, the slots are preferably provided behind the respective barrier wall portions. When the slider units are in the access position, the respective barrier wall portions are positioned transversely outwardly from the guide wall so as to expose and provide access to the respective slots for the tilt arms.

Preferably, the slider units are movable in the length direction of the guide track at the same time as moving transversely along the length of the guide track. In this way, in the access position, the respective barrier wall portions are displaced longitudinally with respect to the openings so as to expose the respective slots in the slider units.

Preferably, the slider units are connected relative to the guide wall by sliding pins engaging in conversion tracks having respective slanted portions.

The slider units may be provided with sliding pins with conversion tracks provided on a support structure or, alternatively, the slider units may be provided with conversion tracks with the sliding pins formed on the support structure.

Preferably, the sliding pins take the form of bushes.

The slider units may be provided on the gate slider with the gate slider movable in the length direction of the guiding track. The gate slider is thus also movable both transversely to and along the length of the guiding track.

In this way, all of the slider units on the gate slider may be moved together.

The slot and gate system may further include a coupler block movable along the guiding track to operate the gate system to open the slots.

Preferably, the plurality of louver holders are arranged as an array along the guiding track and include an extended-most louver holder at the distal end of the array. The extended most louver holder may be arranged to abut and move the coupling block to operate the gate system.

Translatory movement of the coupling block in the length direction of the guiding track is arranged to move the gate slider. When the gate slider is movable in the longitudinal direction, then the coupling block is arranged to move the gate slider in the same direction. Where the gate slider moves only transversely and a longitudinal slider is provided, then the coupling block may be arranged to move the longitudinal slider in the same direction.

Where slider units are used, preferably a detachable attachment is provided between the gate slider and the coupling block for attaching the gate slider and the coupling block. The detachable attachment may be arranged to detach the gate slider from the coupling block when the slider units are in the access position so as to allow additional longitudinal movement of the coupling block.

In this way, the louver holders may continue to move longitudinally such that they are rotated to their closed position.

Rather than use the coupling block arrangement, it is also possible to provide a separate motive means, such as a electric motor, for the gate slider or longitudinal slider. Similarly, individual gates, for instance the gate sliders, could be moved independently.

Preferably, the louver holders are biased towards the closed position. This may be achieved by one or more of a torsion spring and gravity.

Preferably, each tilt arm includes a respective follower pin engageable in a respective slot.

Preferably, the mechanism further includes a plurality of louver carrier trucks movable along the guiding track. Each louver holder may be pivotably journaled on a respective louver carrier truck.

Further advantageous aspects of the invention will become clear from the appended description of preferred embodiments.

The invention will now be described in reference to the accompanying drawings, in which:

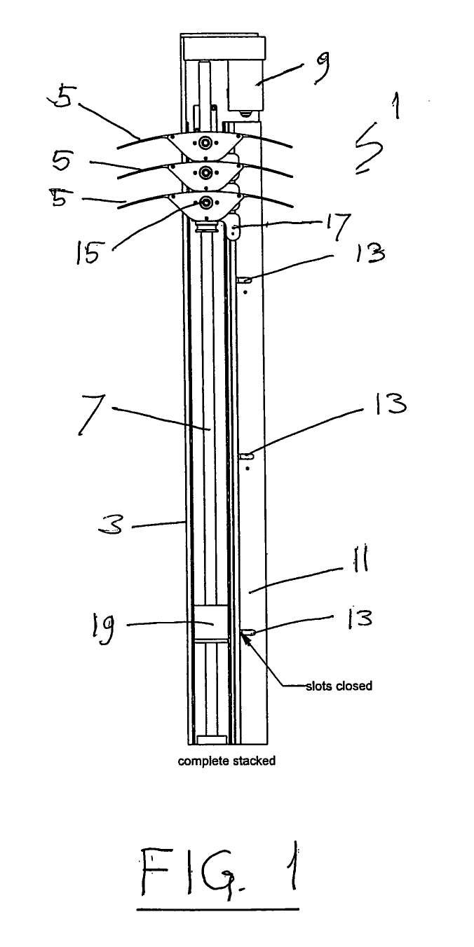

FIG. 1 is a side view of a louver guiding mechanism incorporating a louver rotating mechanism according to the invention;

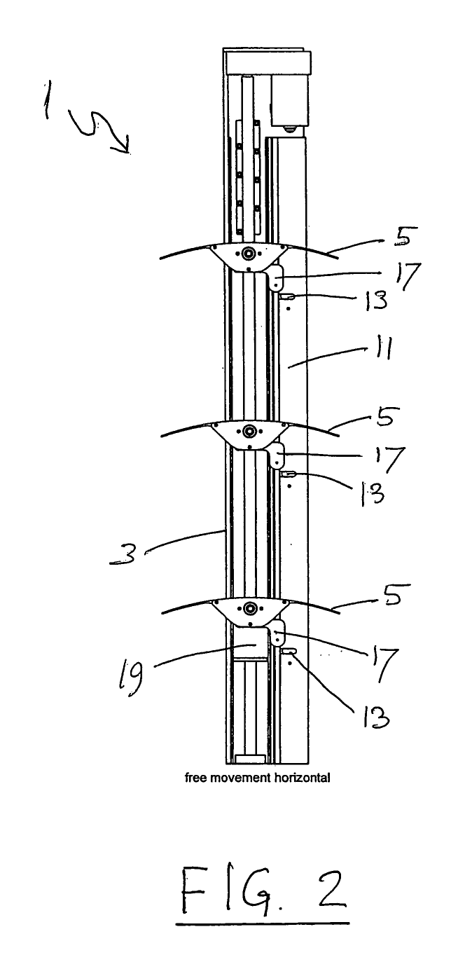

FIG. 2 is a side view similar to FIG. 1, but with the louver holders in a lowered position;

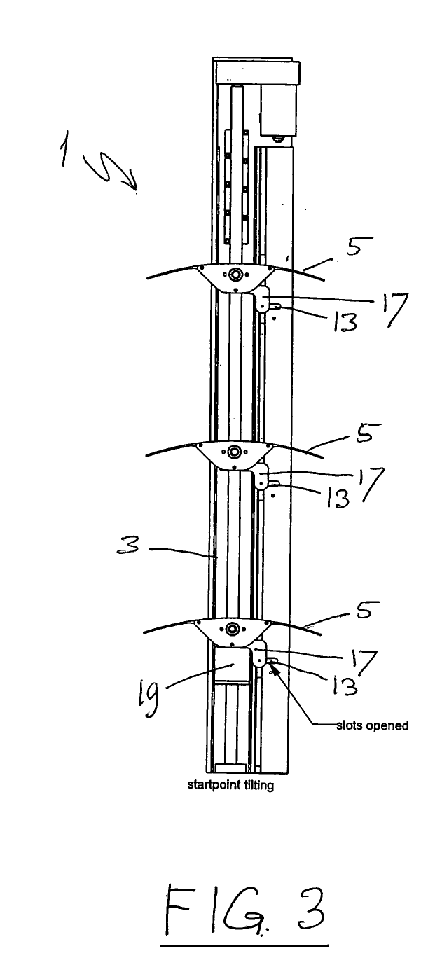

FIG. 3 is a side view similar to FIG. 2, but with the louver holders in an end position ready to be rotated;

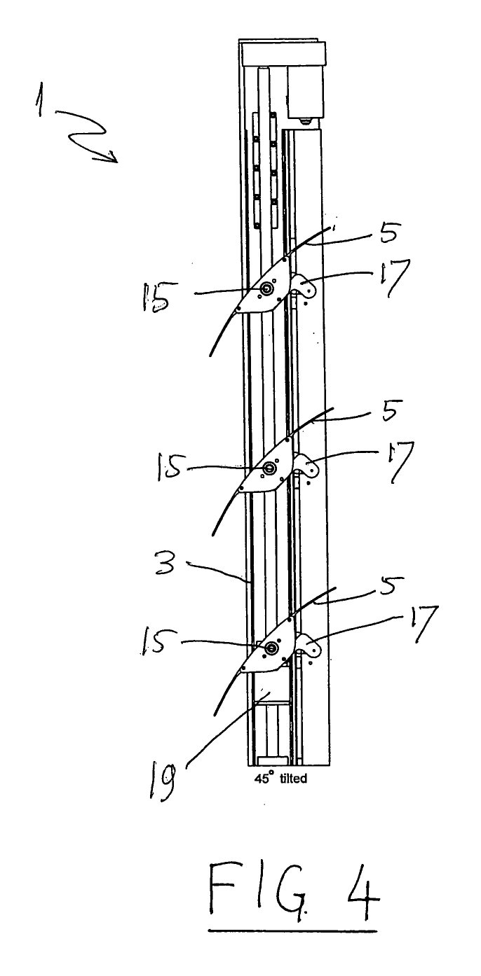

FIG. 4 is a side view similar to FIG. 3, but with the louver holders partially rotated;

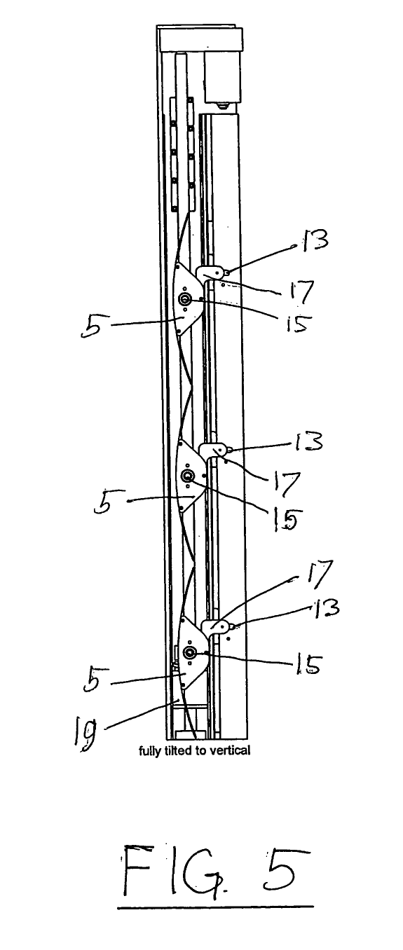

FIG. 5 is a side view similar to FIG. 4, but with the louver holders fully rotated;

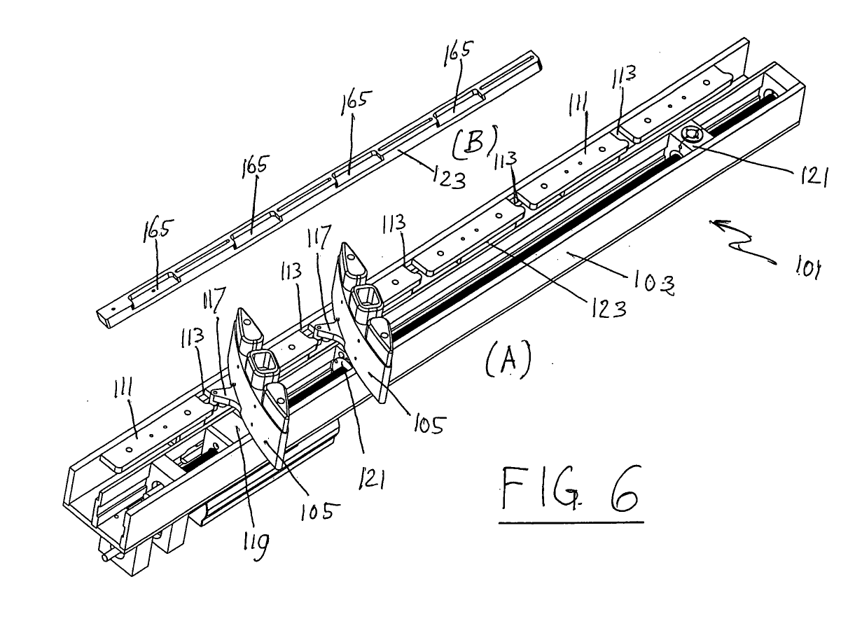

FIG. 6A is a perspective view of a louver guiding mechanism with a louver rotating mechanism according to the invention;

FIG. 6B is a gate slider isolated from the mechanism of FIG. 6B;

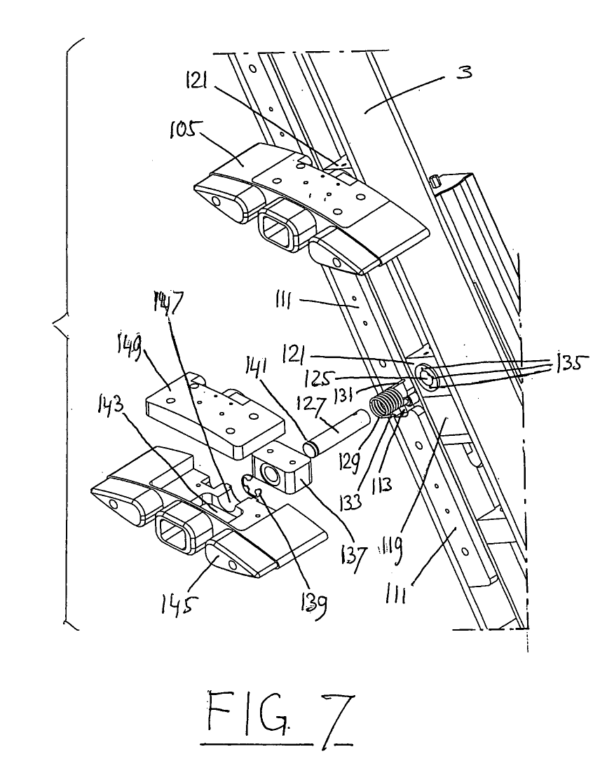

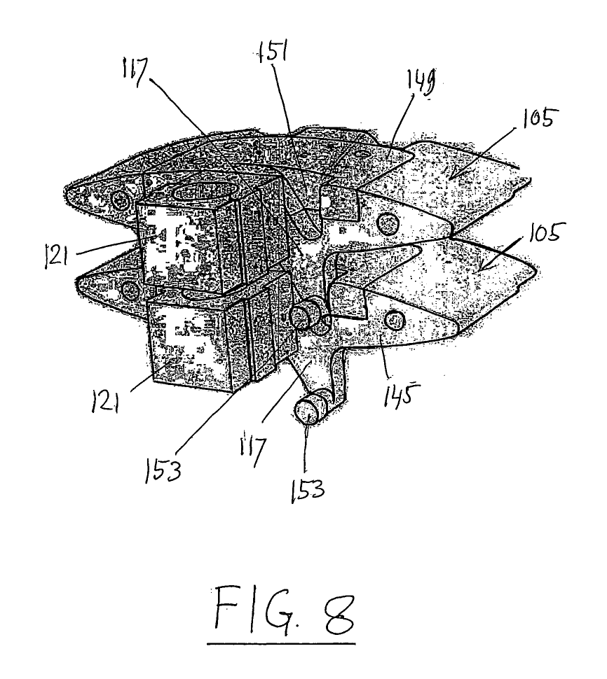

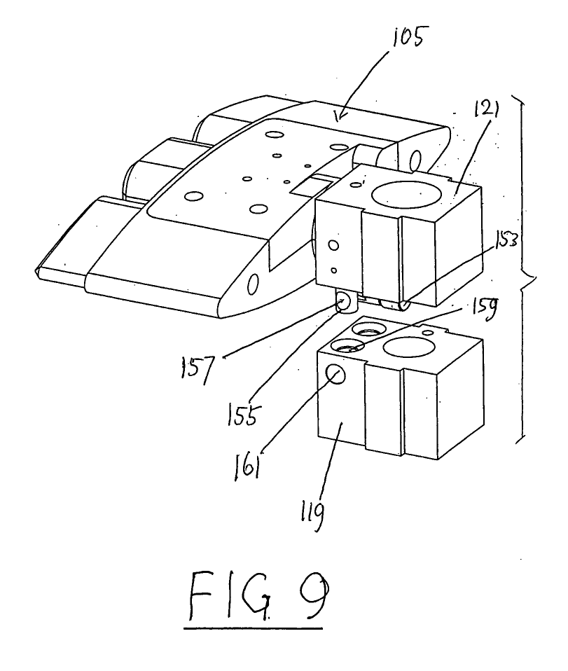

FIG. 7 is a partial exploded view of the louver guiding and rotating mechanism of FIG. 6A;

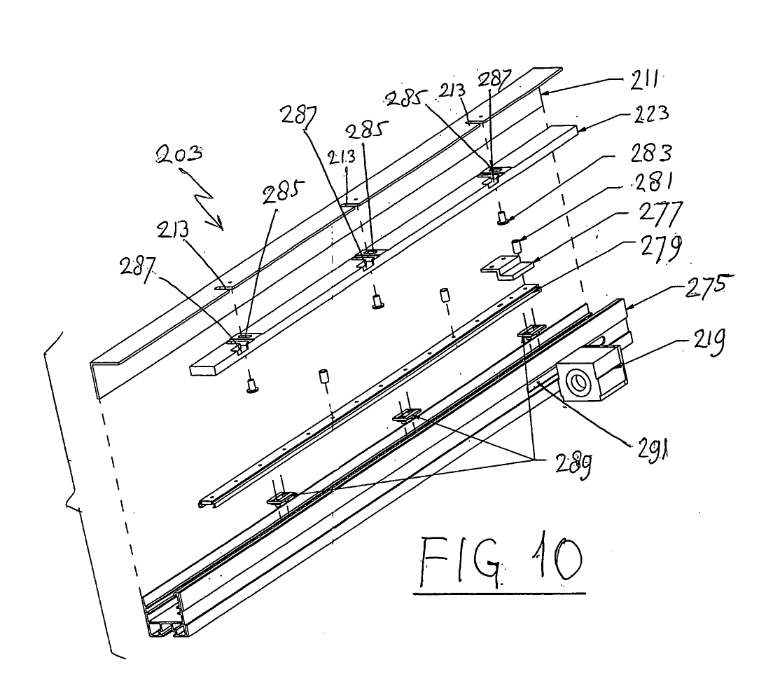

FIG. 8 is a partial perspective view of two stacked louver holders and their associated carrier trucks;

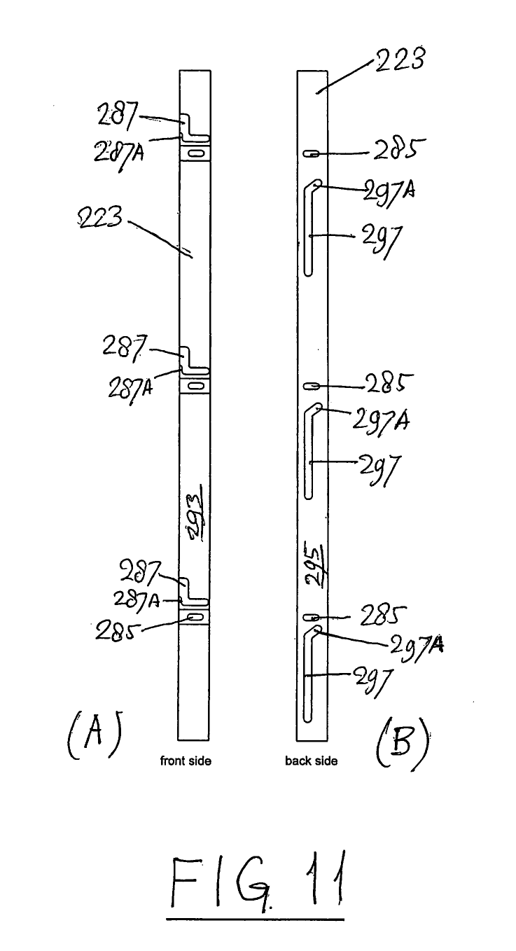

FIG. 9 is a partial perspective view of a lower end of one of the louver holder and carrier truck and a gate slider coupler block;

FIG. 10 is an exploded view of a louver guiding and rotating mechanism according to an alternative embodiment of the invention;

FIG. 11A is a front elevation of a gate slider of the embodiment of FIG. 10;

FIG. 11B is a rear elevation of the gate slider of FIG. 11A;

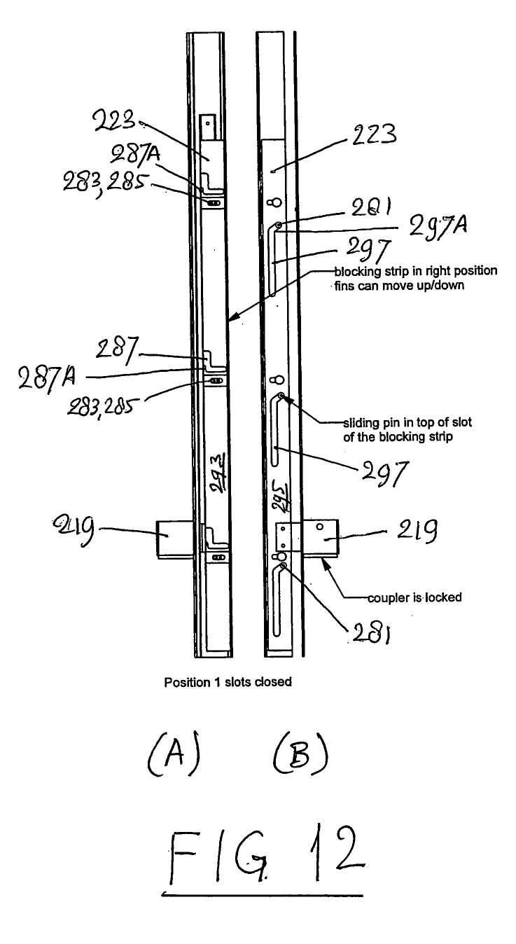

FIG. 12A is a partial cross section from the front side of the louver guiding mechanism of FIG. 10;

FIG. 12B is a partial cross section from a rear side of the louver guiding mechanism of FIG. 10;

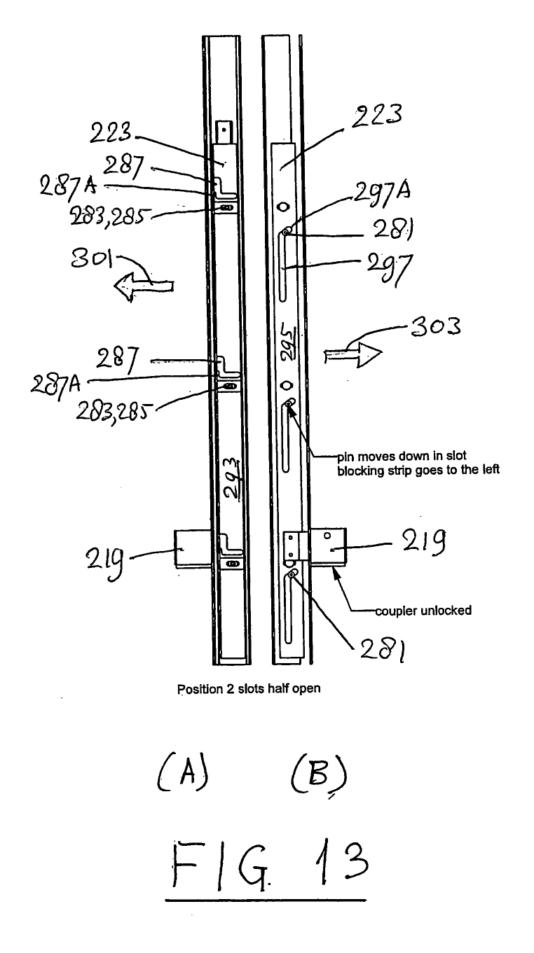

FIG. 13A is a partial cross section similar to FIG. 12A with the transverse slots in a half open position′

FIG. 13B is a partial cross section similar to FIG. 12B with the transverse slots in a half open position.

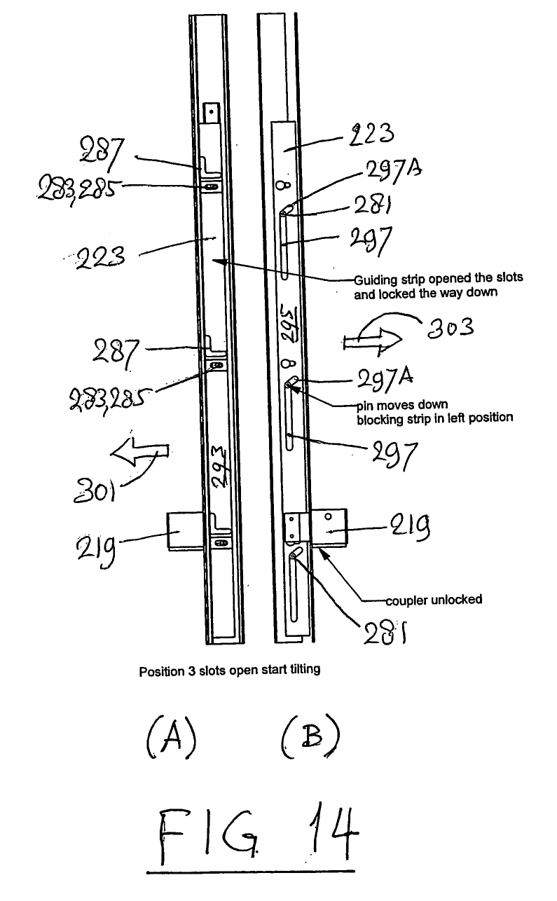

FIG. 14A is a partial cross section similar to FIG. 12A with the transverse slots fully open at the start of louver tilting.

FIG. 14B is a partial cross section similar to FIG. 12B with the transverse slots fully open at the start of louver tilting.

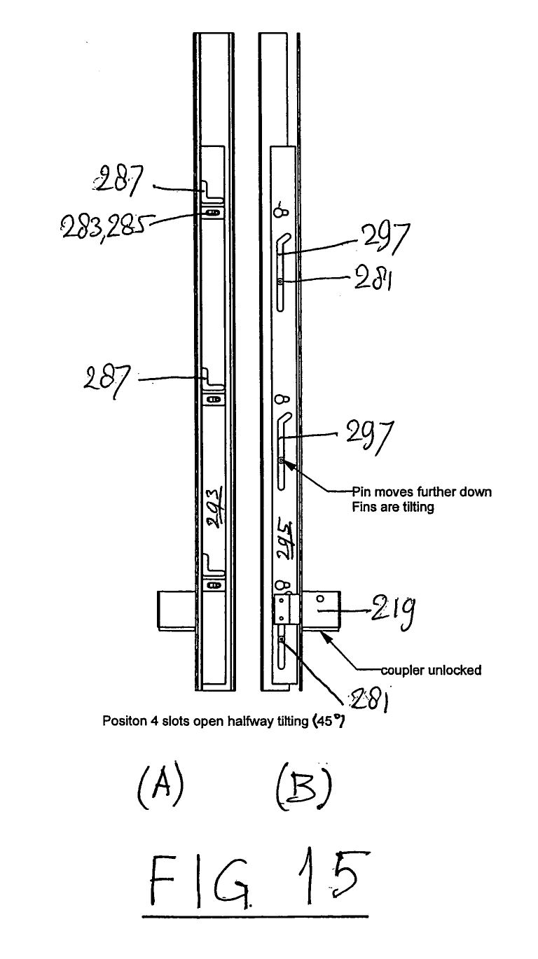

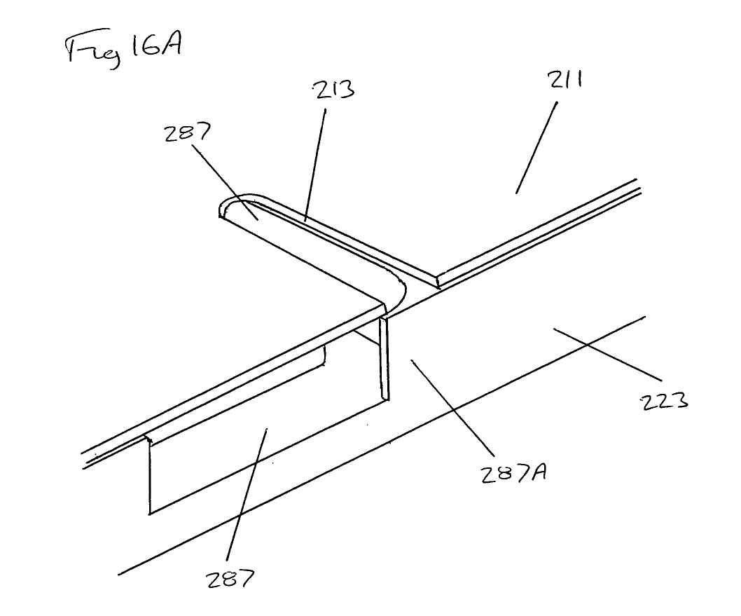

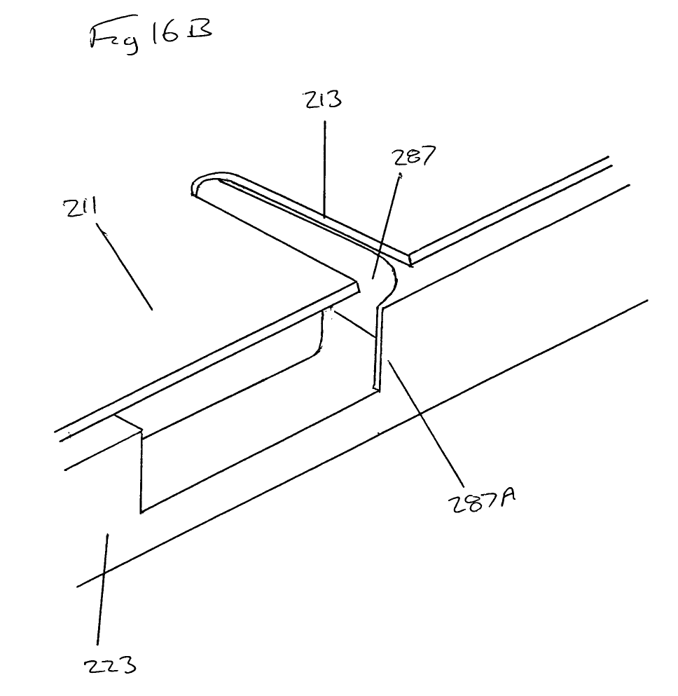

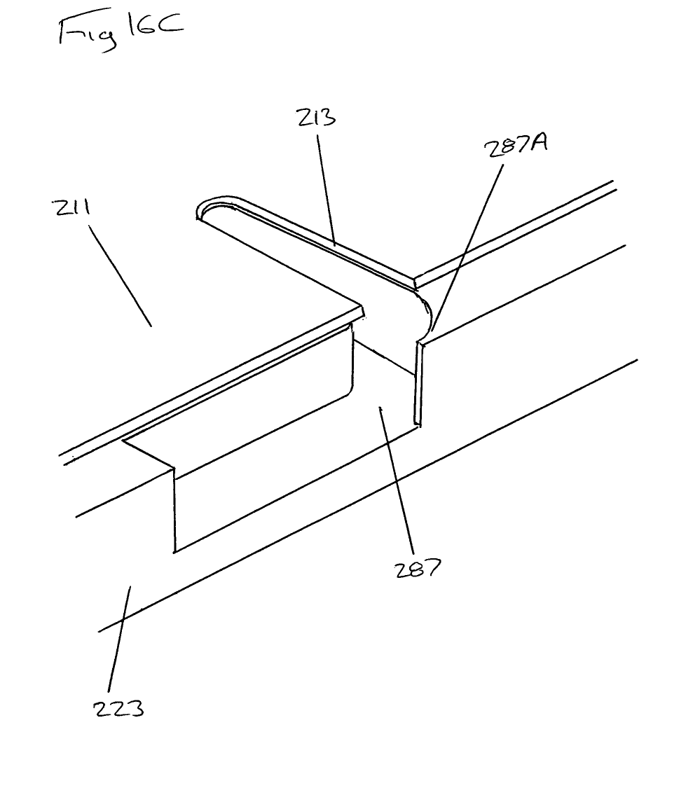

FIG. 15A is a partial cross section similar to FIG. 12A with the transverse slots fully open and halfway through tilting of the louvers;

FIG. 15B is a partial cross section similar to FIG. 12B with the transverse slots fully open and halfway through tilting of the louvers;

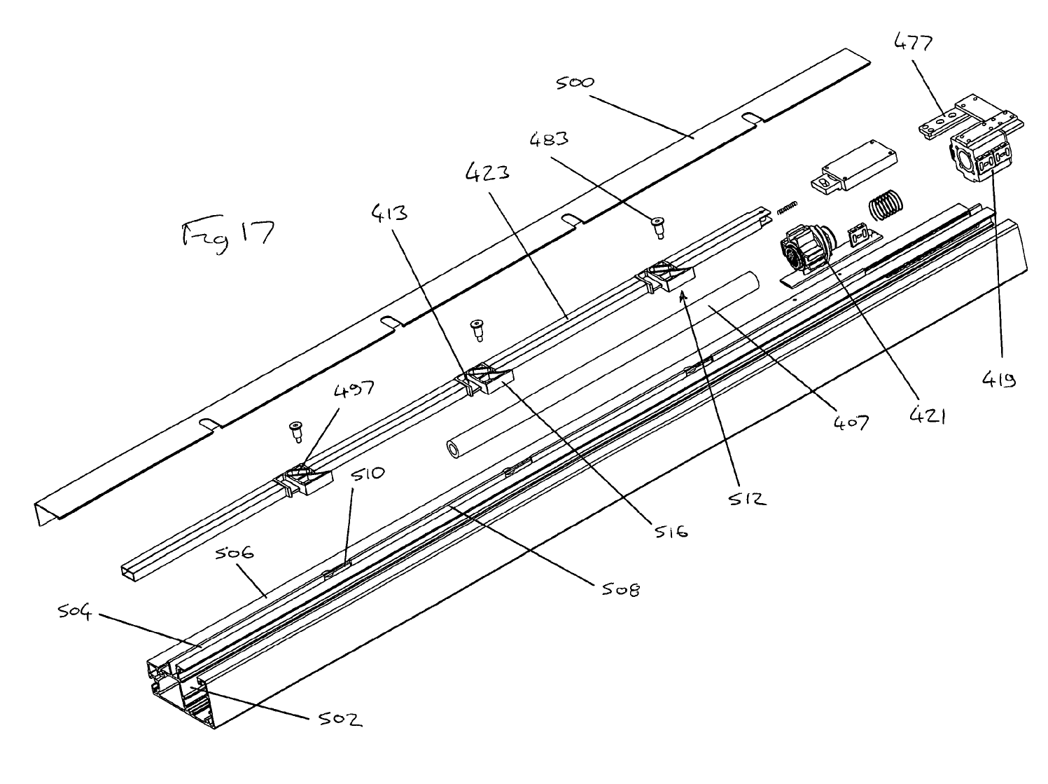

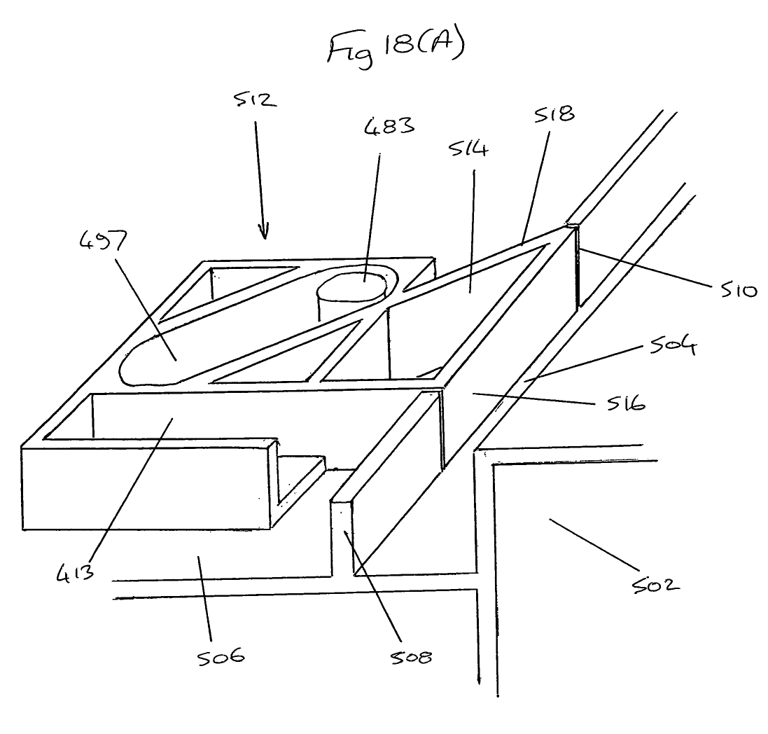

FIGS. 16(A) to (C) illustrate schematically one gate and slot of the alternative embodiment of FIGS. 10 to 15;

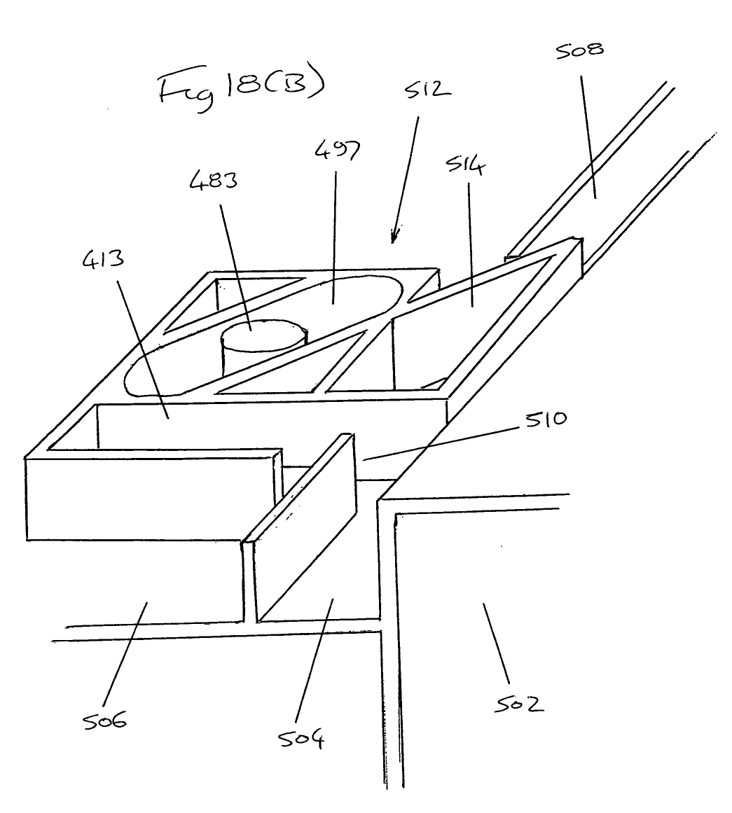

FIG. 17 is an exploded view of a lower guiding and rotating mechanism according to yet another embodiment of the invention;

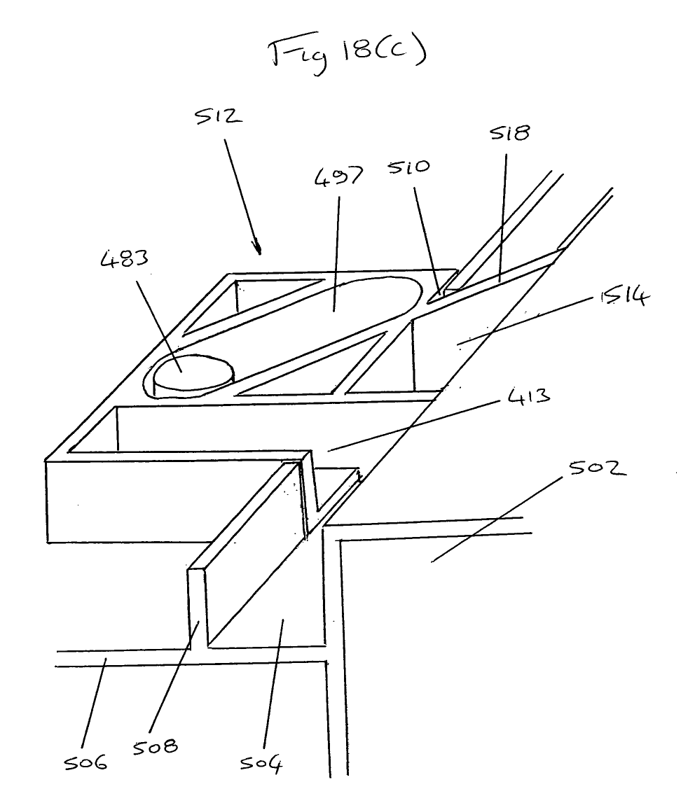

FIG. 18(A) to (C) illustrate schematically one gate and slot of the embodiment of FIG. 17;

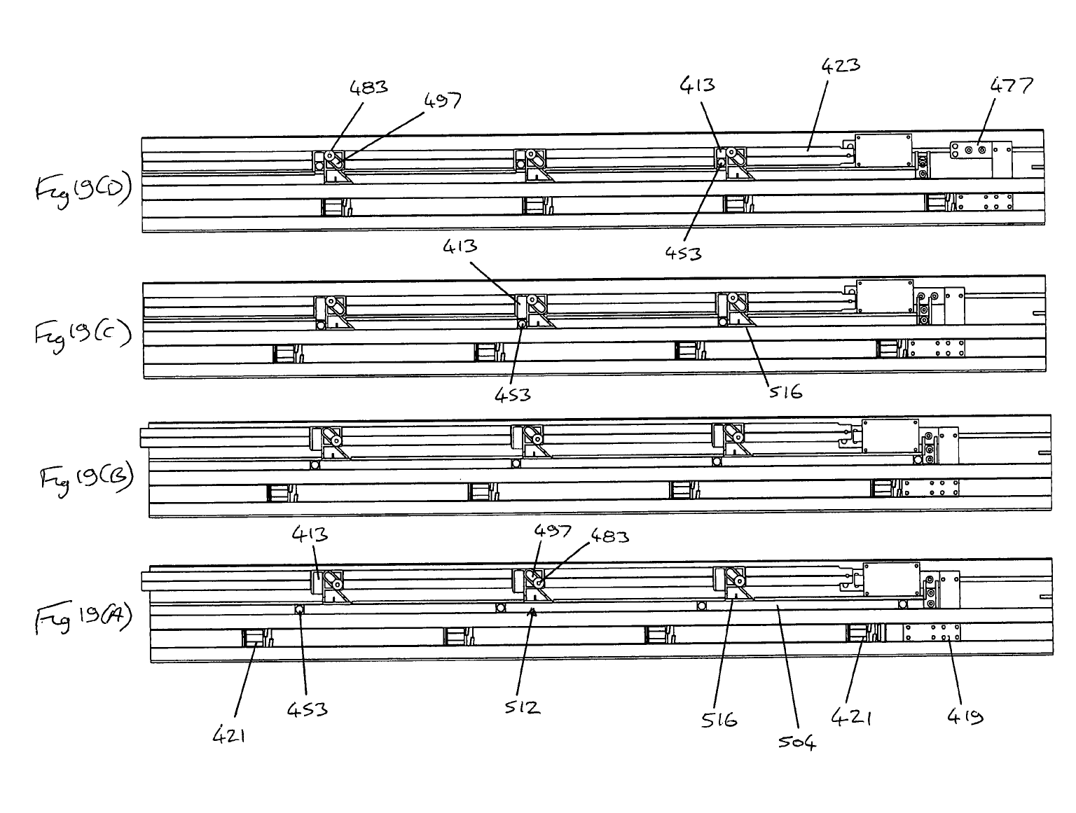

FIG. 19(A) to (D) illustrate operation of the embodiment of FIG. 17;

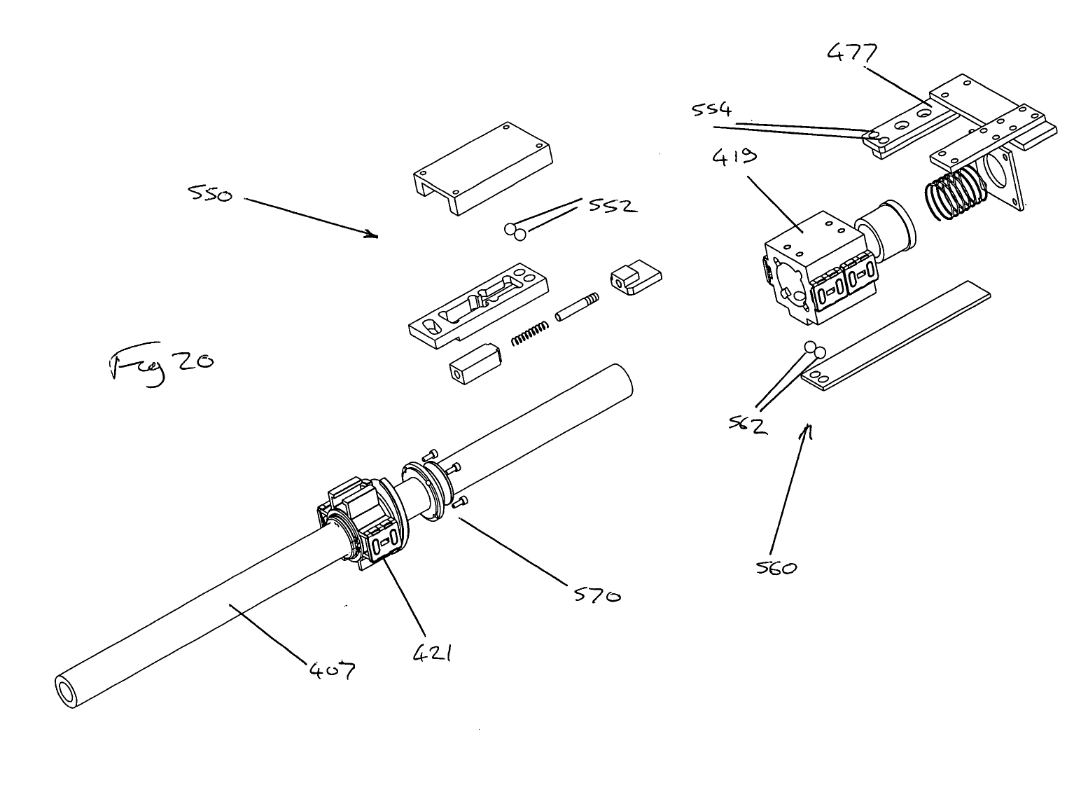

FIG. 20 is an exploded view of part of the embodiment of FIG. 17; and

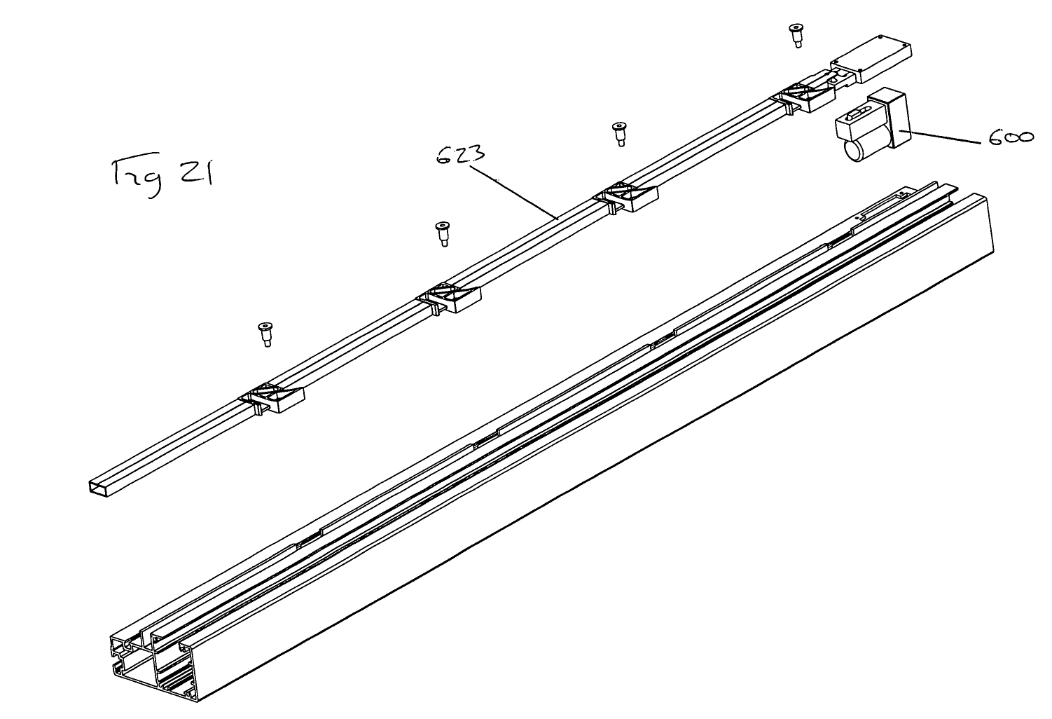

FIG. 21 illustrates a variation to the embodiment of FIG. 17 using a separate motor for the gate system.

In FIG. 1 a louver guiding and rotating mechanism 1 is shown that includes a side guiding channel or track 3. Guided by the guiding channel 3 are a plurality of louver or slat holders 5, which are shown in a stacked position at the top of the side guiding channel 3. Also included in the guide channel 3 may be a mechanism for lowering the louver holders 5. The mechanism for lowering the louver holders 5 is not critical to the invention and may comprise a screw spindle 7 as taught by U.S. Pat. No. 2,179,882, driven by electric motor 9. However, this mechanism for lowering and raising the louver holders can be replaced by a mechanism as taught by EP 369 068, with equally good results. Accordingly a suitable mechanism for moving the louver holders between a retracted and extended position will be known to the skilled person and not require any detailed description in connection with the present invention. The side guiding channel 3 further has a re-entrant front flange 11 with regularly spaced transverse slots 13 opening into a free edge of the re-entrant front flange 11. Each louver holder 5 has a pivot journal 15 and a tilt or pivot arm 17.

Moving now to FIGS. 2 and 3, the louver holders 5 are shown in an extended, and a fully extended position respectively. In FIG. 2 the tilt arms 17 are each approaching a respective one of the transverse slots 13 and in FIG. 3 are each aligned with a respective slot 13.

It is also seen in FIGS. 1 to 5 that the side guiding channel 3 near its lower end has a gate slider coupling block 19. In the position of FIG. 2 the lowermost louver holder 5 is just starting to abut the coupling block 19. In the position of FIG. 3 the lowermost louver holder 5 has moved the coupling block 19 with respect to the side guiding channel 3 in a downward direction. A mechanism to be described herein below is operatively connected to the coupling block 19 to make the transverse slots 13 accessible to the tilting arms 17. FIGS. 4 and 5 show how continued movement of the louver holders 5 in a downward direction along the guide channel 3 allows the tilt arms 17 each to become engaged in the respective transverse slot 13, which causes the louver holders 5 to pivot about their pivot journals 15. In FIG. 5 the fully tilted end position for the louver holders 5 is shown.

FIG. 6 shows a first embodiment of louver rotating mechanism 101 having a guiding channel 103 and louver holders 105. The guiding channel 103 has a re-entrant flange 111 defining transverse slots 113 opening into a free and thereof. The louver holders 105 are each pivotally journalled on a respective louver carrier truck 121, one of which is shown without louver holder for clarity. Each engagement with a respective one of the transverse slots 113. Also shown in FIG. 6A is a gate slider coupling block 119, which operates a gate slider, or slide gate, 123, shown separate in FIG. 6B.

In FIG. 7 one of the louver holders 105 is shown in an exploded arrangement. The louver carrier truck, or louver truck, 121 has a central bore 125 which accepts journal pin 127. Surrounding the journal pin 127 is a helically wound torsion spring 129. The torsion spring 129 has an axially extending tang 131 and a radially extending tang 133 each on a respective opposite end thereof. The axially extending tang 131 is adapted to engage into a hole 135 on the carrier truck 121. A selection of angularly spaced holes 135 may be provided to adjust the torsional torque excerted by torsion spring 129 on the louver holder 105 through its radially extending tang 133. The function of torsion spring 129 is to resiliently bias the louver holders 105 into their tilted positions to ensure proper engagement of the lift arms 117 (FIG. 6A) into the transverse slots 113. An opposite end of journal pin 127 is received in a bearing block 137, and will be retained therein by a locking ring 139 engaging a circumferential groove 141 on one end of the journal pin 127. The bearing block 137 is received in a cavity 143 formed in a louver holder body 145. The torsion spring 129 is accommodated in a barrel cavity 147, also formed in the holder body 145. The assembly of the louver holder 105 is completed by a holder body inlay 149.

As best seen in FIG. 8 the louver holders 105 and carrier trucks 121 are stackable. In the holder body 145 and holder body inlay 149 a recess 151 is formed to accommodate the tilt arms 117 when the louver holders 105 are in a stacked arrangement as shown in FIG. 8. It is also seen in FIG. 8 that the tilt arm 117 can have a follower pin 153, which may be provided as a roller to reduce friction when engaged against the re-entrant flange 111 (FIGS. 6 and 7), or when engaged in one of the transverse slots 113.

FIG. 9 shows the arrangement of a lower most louver holder 105 and carrier truck 121 with respect to the gate slider coupling block 119. The lower most carrier truck 121 is provided with a downwardly extending pin 155, which has a detent recess 157. The gate slider coupling block 119 is adapted to receive the downwardly extending pin 155 of the carrier truck 121. A locking ball 161 movably retained in a transverse bore in coupling block 119 when received in the detent recess 157 of the extending pin 155 will lock the lower most carrier truck 121 to the coupling block 119, for movement in unison therewith.

Reverting now to FIG. 6, the coupling block 119 is operatively connected to gate slider 123, so that translatory movement of the coupling block 119 with respect to the length direction of the guiding channel 103 will move the gate slider 123 in the same direction. As seen in FIG. 6 the gate slider 123 is provided with a plurality of cavities 165, which are spaced in accordance with the successive transverse slots 113 on the flange 111 of the guiding channel 103. Movement of the gate slider coupling block 119 is limited between a first position, in which none of the cavities 165 is in register with a transverse slot 113, and a second position, in which all of the cavities 165 are in register with a relevant one of the transverse slots 113.

In operation the louver holders 105 may be in a stacked position as shown in FIG. 1. When from this position the louver holders are lowered by an appropriate lowering mechanism (such as those disclosed by U.S. Pat. No. 2,179,882 or EP 369 068), the lowermost carrier truck 121 will be advanced through the guide channel 103 in the direction of the gate slider coupling block 119. The other carrier trucks 121 will be advanced either directly by the lowering mechanism (as in the case of U.S. Pat. No. 2,179,882) or indirectly by the lowermost carrier truck (as in the case of EP 369 068). During this movement the tilt arms 117 of the louver holders 105 will be biased by torsion springs 129 against the free edge of re-entrant flange 111. With the carrier trucks 121 thus moving from a stacked position in the direction of the gate slider coupling block 119, the gate slider 123 (see FIG. 6) will have its cavities 165 out of alignment with the open ends of the transverse slots 113, so that the follower pins 153 on the tilt arms 117 cannot enter the transverse slots 113. Towards the end of travel of the lowermost carrier truck 121 this will abut against the gate slider coupling block 119. The gate slider 123 is connected to the coupling block 119 for translatory movement therewith in the length direction of the side guiding channel 103. Engagement of the downwardly extending pin 155 of the lowermost carrier truck 121 with the coupling block 159 will allow the locking ball 161 to move inwardly into the detent recess 157, which effectively unlocks the coupling block 119 from the guiding channel 103. Continued movement of the lowermost carrier truck 121 will then start to move the coupling block 119 in the same downward direction and thereby gradually move the cavities 165 of the gate slider 123 into register with the respective open ends of the transverse slot 113. Simultaneously the follower pins 153 of the tilt arms will each engage into a relevant one of the transverse slots 113. This corresponds to the position of the slot holders shown in FIG. 3. Further movement, as allowed by the coupling block 119, will then enable the louver holders 105 to tilt to any position between horizontal and vertical, as shown by the examples of FIGS. 4 and 5. Reverse movement of the lowermost carrier truck 123 will first take with it the coupling block 119, by means of the locking ball 161 being engaged with the detent recess 157 of the downwardly extending pin 155 of the lowermost truck 121. The louver holders will thereby pivot in a reverse direction from that shown in FIGS. 3 to 5, until the coupling block 119 returns to its initial position with the coupling block 119 returned to its initial position, the locking ball 161 can move outwardly again to lock the coupling block 119 again to the guiding channel 103, whereby the downwardly extending pin 155 of the lowermost truck 121 becomes unlocked and allows all the carrier trucks 121 to move upwardly, as desired, until the stacked position shown in FIG. 1. In the meantime also the gate slider 123 (FIG. 6) will have returned to a position in which it closes the open ends of the transverse slots 113. While moving along the guide channel, there is thereby no risk that the follower pins 153 of the tilt arms 117 become engaged in any of the transverse slots 113 they may pass en route to their stacked position.

In accordance with the invention, the louver rotating mechanism 101 is made up of various components acting together to cause louvers or louver holders 105 to rotate to a closed position when the group of louver holders 105 is fully extended. Also in accordance with the invention, the rotating motion may be achieved using the same motor and transmission of power that stacks the louver holders 105.

The basic components of the system are; the track 103 and carrier trucks 121, the torsion spring loaded louver holders 105, the slot and slide gate operating system, and the ball transfer locking coupler block 119.

Even though the described embodiment has been built to rotate the louver holders 105 in the fully extended position, the mechanism can be modified with the option of having a separate motor or solenoid actuating the slider gate 123 so the louvers or louver holders 105 could be rotated at any position in between fully extended and fully retracted. Furthermore, the slider gate 123 can be constructed in two or more independently actuated segments so that regions of louvers within a louver panel may be rotated open while the other regions remain closed. This is possible because each louver holder 105 rotates independently under its own spring 129 load. However, it should be noted that if the louvers are rotated in any position other than at full extension a more complex limit switching device would be needed for the motor.

The louver holder 105 can be made up of two halves that mate so the spring and bushing system may be assembled. This split design could also help in the replacement of louvers in the system. The spring 129 and shaft 127 need to have bearing surfaces on both ends of the torsion spring 129 for smooth friction-free rotation. At the end of the louver holder 105 is an annular recess which couples with a protrusion on the main carrier truck 121. On the opposite end of the torsion spring 129 inside the louver holder 105 is a bearing block 137. The torsion spring 129 is designed to add torque so it will bias the louver holder 105 to the closed position when allowed by the gate system.

While the described embodiment uses a relatively large holder 105 for the above stated reason, the same spring loaded bushing and spring mechanism may be inserted directly into an extrusion with a narrow end plate and tilt arm in order to keep the cost down. The described embodiment was designed as an extrusion, but may in fact be obtained by any other appropriate shaping technique.

When the torsion spring 129 is twisted, it grows a little in the coil length so some space is needed in the barrel cavity housing the spring 129. Additionally, in order to help it remain engaged in the carrier truck 121, the torsion spring 129 is designed also to act as a compression spring 129. Force from this compression component pushes the tang 131 at the end of the spring 129 into a hole 135 in the carrier truck 121. In the described embodiment truck body 121 there are four holes 135 for spring engagement. This allows for some adjustability of torsion force. The holes 135 are positioned at 90 degrees increments. The spring 129 is conveniently made from series 302 stainless steel and it is thereby rated for around 50,000 cycles. By spring-loading the individual louver holders 105, the entire system is designed to place as small a torque load on the motor and linkages so as to require a small motor and to minimize maintenance.

Each louver holder 105 has a tilt arm 117 that controls the tilting with a follower pin or roller 153. As the louver truck 121 carries the louver holder 105 up and down the track 103, the follower 153 rides on the surface of a slot and gate system. When the gates are closed the louver holders 105 ride freely up and down the track with the louvers in the open position. When the bottom louver carrier truck 121 reaches the bottom of the track 103, it engages a coupler block 119 which attaches itself to the louver truck 121 and moves with it. As the coupler block 119 is moved downward it pulls a gate system 123 down and this opens all the slots 113 allowing every louver follower 153 to slide into its respective slot and thus rotate the louvers in unison.

When the gates are opened, the follower 153 rolls around a slot profile 113 designed to move the tilt arm 117 and rotate the louver holders 105. For the current embodiment there are proposed three basic slot profiles; simple radius, simple chamfer, and a lobed radius profile. The profile versions may be swapped for various applications. It will be good to test each possible application for smooth transitions and for required torque on the motor. An extended shaft may further be provided on a bottom end of the described embodiment to enable testing with alternate motors or a hand crank.

The coupler block 119 that is connected to the gate slide 123 engages with the bottom carrier truck 121 and triggers the slide action of the gates. It is an elegantly simple design that functions very well doing a complex task. When the bottom louver carrier truck 121 is up away from the gate slider 123 coupler block 119, the gate slider coupler block 119 is locked in position. This prevents the gates from opening at the wrong time. As the bottom louver carrier truck 121 approaches the gate slider coupler block 119, it releases it from its locked position and the coupler block 119 and louver truck 121 become attached to each other. This is important because when the bottom louver carrier truck 121 reverses direction, it needs to cause the gate slider coupler block 119 to close the gates. The pulling action of the bottom louver carrier truck 121 pulls the gate slider coupler block 119 as reliably as it pushes in the other direction. This is achieved with the transfer ball and detent system 157, 161.

In reference to FIGS. 10 to 16 a side guiding channel or track 203 will be described which uses an alternative form of slot and gate system. In FIG. 10 the components making up the alternative slot and gate system are shown in an exploded arrangement. The side guiding channel 203 includes a main profile 275 a gate slider coupling block 219, a slotted flange 211, a gate slider 223 and a coupling block connector 277. The slot and gate system of FIGS. 10 to 15 differs from that described in reference to FIGS. 6 to 9, in that the gate slider 223 is movable only transversely to the length of the guiding channel 203, rather than longitudinally thereof. Accordingly the slot and gate system of FIGS. 10 to 15 has an additional intermediate slider 279, from which sliding pins 281 project at predetermined locations along its length. The sliding pins 281 are for connecting the intermediate longitudinally sliding slider 279 to the transversely movable gate slider 223. The gate slider 223 is transversely slidable connected to the slotted flange 211 by means of bushes 283, engaged through transverse mounting slots 285 in the gate slider 223. Further the gate slider 223 is provided with a plurality of gate recesses 287, which confront relevant transverse slots 213 in the flange 211. The intermediate slider 279 is longitudinally slidable retained to the main profile 275 by means of slide supports 289. The coupling block connector 277 is attached to the intermediate slider 279 and connects to the coupling block 219 through an elongate slot 291 in a wall portion of the main profile 275.

As respectively shown in FIGS. 11A and 11B the gate slider 223 has a front side 293 and a rear side 295. The front side 293 is provided with the gate recesses 287, while the mounting slots 285 extend through the gate slider 223 to both sides of the gate slider 223. The rear side 295 is provided with conversion tracks 297, in which the sliding pins 281 of the intermediate slider 279 are adapted to engage. The conversion tracks 297 each have a slanted end portion 297A. It is also shown in FIG. 11 that the gate recesses 287 each have a barrier wall portion 287A.

Referring now to FIGS. 12 to 15, the operation of the alternative slot and gate system will be explained.

In FIG. 12A the gate slider 223 is shown in its extreme right hand blocking fully beneath the slotted flange 211 position, with the barrier wall portions 287A effectively blocking access to the transverse slots 213. Although not shown in FIG. 12A, the transverse slots 213 are aligned with the horizontal transverse recess parts of gate recesses 287. FIG. 12B shows the corresponding position of the gate slider 223 as viewed from the opposite side (extreme left hand position). The coupling block 219, in FIGS. 12A and 12B, is in an extreme top longitudinal position together with the sliding pins 281. The sliding pins 281 are thus located in the slanted top portion 297A of the conversion tracks 297. As a result the gate slider 223, by virtue of the slanted portion 297A of the conversion tracks 297, has started to move outwardly from under the slotted flange 211.

FIG. 16A illustrates one slot 213 and gate slider 223 in this state.

In FIG. 13A the gate slider has started to move gradually from its position in FIG. 12A in the direction of arrow 301.

In this intermediate position the transverse slots 213 (see FIG. 10) will still be blocked by the barrier wall portions 287A. This movement is caused, as shown in FIG. 13B by the coupling block 219 being moved in a downward direction by an endmost louver carrier truck (not shown, but identical to those shown in the embodiment of FIGS. 6 to 9). Movement of the coupling block 219 in a downward longitudinal direction causes movement of the sliding pins 281 in the same downward direction. This is so because the sliding pins 281 move together with the intermediate slider 279 (which is deleted from FIGS. 12 to 15). Through the slanted end portion 297A, the vertical longitudinal movement of the sliding pin 28 will be converted into a horizontal transverse movement of the gate slider 223 in the direction of arrow 303.

FIG. 16B illustrates the slot 213 of FIG. 16A in this state.

In FIG. 14A the gate slider 223 has reached its extreme left hand access position by completing its movement in the direction of arrow 301. As a result the open end of the gate recesses 287 will now be accessible to the follower pins 153 (identical to the embodiment of FIGS. 6 to 9), which will thus be guided to the horizontal transverse recess part of the gate recess 287 and be able to enter the relevant transverse slot 213 (see FIG. 10). Similarly FIG. 14B shows from the rear side how the sliding pins 281 have progresses to the junction between the slanted end portion 297A and the vertical longitudinal section of the conversion track 297. Thereby the gate slider 223 cannot move any further in the direction of arrow 303.

FIG. 16C illustrates the slot 213 of FIGS. 16A and B in this state.

As seen in FIGS. 15A and 15B, further vertical longitudinal movement of the coupling block 219 and the sliding pins 281 will have no further effect on the position of the gate slider 223. However through the carrier truck 121, connected to the coupling block 219 the slat holder pivot journals (15 in FIGS. 1 to 5) will continue to move in a vertical longitudinal direction. At the same time the follower pins 153 on the tilt arms 117 (FIGS. 6 to 9) are engaged in the transverse slots 213 and will thus initiate tilting of the louver holders 105 (FIGS. 6 to 9).

An alternative form of slot and gate system is now described with reference to FIGS. 17 to 21. Like parts use similar reference numerals, but in the 400 series.

FIG. 17 illustrates a mechanical version of the embodiment using a guiding track 403 with a gate slider 423. Other similar embodiments are possible using gates which are separately actuable, individually or together, for instance with electrical motors or solenoids.

The embodiment of FIG. 17 is illustrated with a cover 500. Although this cover looks similar to the re-entrant front flange 11, 111, 211 of earlier embodiments, it does not provide the re-entrant function and is not necessary for functioning of the invention in this embodiment. As will be described below, the transfer slots of this embodiment are provided in slider unit, each preferably provided as part of the gate slider 423. The louver tilt mechanism of this embodiment functions correctly without the cover 500. The cover 500 is provided only to close the arrangement and protect it against dirt.

As illustrated, the guiding track 403 is provided as a main track 502, together with a secondary track 504. The main track 502 thus forms the main portion of the guiding track of earlier embodiments. It houses the louver carrier trucks 421 (only one shown in FIG. 17) and the spindle 407 which can be rotated to move the louver carrier trucks 421. The spindle 407, although not illustrated, includes an outer thread for moving the louver carrier trucks 421. Of course, as with earlier embodiments, any other appropriate mechanism for moving the louver holders can be provided.

The secondary track 504 runs alongside the main track 502 and, hence, extends in the same longitudinal direction as the guiding track 403. As illustrated most clearly in FIGS. 18(A) to (C), a support wall 506 extends outwardly and transversely from the main track 502. Extending upwardly from the support wall 506 is a guide wall 508 which extends alongside the guiding track formed by the main track 502 and defines therebetween the secondary track 504.

As illustrated, the guide wall 508 is provided with spaced apart openings 510 along its length.

A plurality of spaced apart slider units 512 are provided for respective openings 510. Although the slider units 512 could be provided individually (for instance actuated by respective solenoid devices), in the illustrated embodiment, gate slider 423 is provided as an elongated profile with the spaced apart slider units 512. Each slider unit 512 includes a gate closing member 514 forming a barrier wall portion 516, a transfer slot 413 and a diagonal mounting slot or conversion track 497.

The gate closing member 514 is shaped generally as a right-angle trapezium, or in American English trapezoid, also known as a quadrilateral with two opposite parallel sides, a right angle and only one slanted side. The gate closing member 514 sticks out from the elongated profile of the gate slider 423. Its longest or base side forms the barrier wall portion 516 for closing a respective opening 510 in the guide wall 508 of the secondary track 504.

As illustrated, behind the barrier wall portion 516, there is provided a square portion in which the diagonal conversion track 497 is formed. The conversion track 497 can also be considered to be equivalent to the mounting slots 285 of the previous embodiment. However, whereas the mounting slots 285 of the previous embodiment were arranged only transversely, the diagonal conversion slot 497 of the present embodiment extend both transversely and longitudinally. Similar to the previous embodiment, the diagonal conversion tracks may be secured to the support wall 506 by means of bushes or sliding pins 483. As illustrated, the conversion tracks 497 have the same angle as the slanted sides 518 of the gate closing members 514 and effectively form extensions thereof.

As mentioned above, the transverse slots of previous embodiments are formed in respective slider units 512. In each slider unit 512, the transverse slot 413 is positioned parallel and adjacent to the right angle side of gate closing member 514 and the square portion in which the conversion tracks 497 are formed.

In operation, the plurality of gates of the slot and gate system are formed by respective openings 510, barrier wall portions 516 and transverse slots 413. In operation, the gates may be either closed by the gate slider 423, partially opened or fully opened. The gates are closed when the barrier wall portions 516 fill their respective openings 510 and are positioned in parallel with the guide wall 508. In this closed position, the gates will force the follower pins of the tilt arms of louver holders to travel along the secondary track 504. In this way, the louver holders are moved along the guiding track 403 such that they are deployed or stacked.

General operation of the slot and gate system can be achieved in a manner similar to the embodiments discussed above. In particular, when a lower or extended-most louver holder reaches the coupling block 419 such that its louver truck 421 abuts the coupling block 419 and connects to it, further movement of the louver holder and louver truck 421 moves the coupling block 419 and also the gate slider 423 so as to open the gates by means of the slider units 512. For the present embodiment, a slider connector 477 is provided to connect the coupling block 419 to the gate slider 423.

As will be apparent from the description given above, due to the diagonal orientation of the conversion tracks 497, movement of the gate slider 423 to open the gates will be both transverse and longitudinal with respect to the guiding track 403. In particular, the movement is guided by the bushes or pins 483 in the diagonal mounting slots forming the conversion tracks 497.

When the gate slider 423 is moved longitudinally by the coupling block 419 so as to open the gates, the gate closing member 514 slides longitudinally and transversely through the opening 510 into the secondary track 504 as illustrated in FIG. 18(B). When the barrier wall portion 516 reaches the opposite inner wall of the secondary track 504, the transverse slot 413 of the slider unit 512 is positioned in line with the respective opening 510 as illustrated in FIG. 18(C). Hence, the transverse slot 413 has been opened. Additionally, the gate closing member 514 acts to block the secondary track 504. A follower pin of a tilt arm of a louver holder moving along the secondary track 504 will be blocked and guided into the transverse slot 413 so as to cause subsequent closing of the louvers in a manner as described for previous embodiments.

Thus, the combination of the gate closing member 514 in the closed position with the transverse slot 413 adjacent the opening 510 so as to receive the follower pin forms a gate recess similar to the gate recesses described above.

A preferred feature of the present embodiment is that the gate slider 423 can be coupled to and uncoupled from the coupling block 419 and its connector 477. In particular, a detachable attachment is provided. In particular, once the respective slider units 512 have moved with the gate slider 423 to the open position, in order to allow the follower pins to remain stationary whilst the louver holders continue to move (and thereby tilt), the slider 423 uncouples from the connector 477 and thus also from the coupling block 419. This allows the extended-most louver truck 421 to continue to move the coupling block 419 longitudinally of the guiding track 403.

The coupling between the slider 423 and connector 477 forming the detachable attachment may be a ball-coupling. It is also possible to provide a coupling between the coupling block 419 and the extended most louver truck 421 and this may also be a ball coupling. Ball couplings are well known in the art and very convenient for this embodiment, because they can operate without restraint as to position (vertical, slanted, horizontal) of the louver shutter. If a coupling is not provided between the coupling block 419 and the extended most louver truck 421, it is also possible to use other means to ensure that the coupling block 419 moves back to its original position when the extended most louver truck 421 retracts, for instance a spring biasing the coupling block 419 to that position.

Operation of the gate slider 423, the coupling block 419 and the connector 477 will now be given with reference to FIGS. 19(A) to (D) with particular detail of an individual slider unit 512 illustrated in FIGS. 18(A) to (C).

FIG. 19(A) shows the system in the situation where several louver trucks 421 have run along the spindle 407 towards the coupling block 419. The extended most end louver truck 421 is near the coupling block 419. In the secondary channel 504, follower pins 453 of the louver holders are shown. The gates are in the closed position with the barrier wall portions 516 in the openings 510 as illustrated in FIG. 18(A). Also shown are the conversion tracks 497, sliding pins 483 and transverse slots 413.

In FIG. 19(B), the extended most louver truck 421 abuts the coupling block 419. The coupling block 419 is, at this time, still connected to the slider 423 by means of the connector 477, for instance with an intermediate ball coupling. The slider units 512 are still positioned as illustrated in FIG. 18(A).

Further movement of the louver holders and their respective trucks 421, for instance by means of rotation of the spindles 407 in the illustrated embodiment, will move the coupling block 419, the connector 477 and the gate slider 423.

FIG. 18(B) illustrates an intermediate position where the gate slider 423 has been moved longitudinally. By virtue of the respective conversion tracks 497, the slider units 512 and, hence, the gate slider 423 have also moved transversely. As illustrated, the gate closing member 514 has moved transversely through the opening 510 into the secondary track 504.

In FIG. 19(C), gate slider 423 has been moved fully both longitudinally and laterally such that the gate closing member 514 has slid longitudinally and laterally through the opening 510. As illustrated in FIG. 18(C), the transverse slot 413 is now presented in the opening 510 and is available to a follower pin 453.

As illustrated in FIG. 19(D), further movement of the coupling block 419 and connector 477 has pulled the connector to release from the ball coupling and thus from the gate slider 423. In this way, the gate slider 423, its slider units 512 and the respective follower pins 453 remain stationary during further movement of the louver holders and their louver trucks 421. As a result, the louver holders and their louvers are tilted.

FIG. 20 provides an illustration of further details of a preferred ball coupling between the gate slider 423 and connector 477 and also a preferred ball coupling in the coupling block 419 for connection to the extended most louver truck 421. The ball coupling 550 between the gate slider 423 and connection 477 includes a pair of balls 552 engageable in respective dimples 554 in the connector 477. Similarly, the ball coupling 560 in the coupling block 419 includes a pair of balls 562 for engagement with dimples in the extended most louver truck 421.

FIG. 20 also illustrates a collar 570 to end the extended most louver truck 421.

As mentioned for previous embodiments, it is possible to use a second motor for controlling the gate slider instead of a mechanically integrated gate system. As illustrated in FIG. 21, a second motor 600 is installed to move the gate slider as required. Control of the second motor may be linked (by limit switches or electronically) to the position of the louver holders and their louver trucks with respect to the openings in the guide wall. This obviates the coupling block connecting the slider to the trucks.

It should be noted that while the embodiment of FIGS. 6 to 9 proposes louver holders that are biased towards their tilted position, it is also possible to provide for such bias through gravity or through positive drive of the slats as e.g. by the spindle 7 as proposed in U.S. Pat. No. 2,179,882 and thus eliminate the torsion springs (129). In particular the slot and gate system of FIGS. 10 to 16 and of FIGS. 17 to 21, would be well adapted to such gravity biased or positively driven louvers and/or louver holders.

It is thus believed that the operation and construction of the present invention will be apparent from the foregoing description. The invention is not limited to any embodiment herein described and, within the purview of the skilled person; modifications are possible which should be considered within the scope of the appended claims. Equally all kinematic inversions are considered inherently disclosed and to be within the scope of the present invention. The term comprising when used in this description or the appended claims should not be construed in an exclusive or exhaustive sense but rather in an inclusive sense. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. Features which are not specifically or explicitly described or claimed may be additionally included in the structure according to the present invention without deviating from its scope.

1. A louver rotating mechanism for louvers of a sectional covering for architectural openings, the rotating mechanism being adapted to rotate the louvers between an open position, in which the louvers are in generally parallel planes, and a closed position, in which the louvers are generally in a common plane, wherein the rotating mechanism includes a slot and gate system.

2. A louver rotating mechanism according to claim 1 further including:
a guiding track;
a plurality of louver holders for holding respective louvers, each louver holder movable along the guiding track and pivotable so as to rotate a respective louver between the open position and the closed position;
a mechanism for moving the louver holders along the track between retracted and extended positions; wherein
the slot and gate system includes a plurality of slots spaced along the guiding track, each slot extending substantially transversely to the guiding track;
each louver holder includes a respective tilt arm engageable in a respective slot such that movement of each one of the louver holders, when the tilt arm of said one of the louver holders is engaged in a respective slot, causes said one of the louver holders to pivot so as to rotate a respective louver between the open position and the closed position; and
the slot and gate system includes a gate system for closing the slots so as to prevent the tilt arms from engaging in the slots and for opening the slots to allow the tilt arms to engage in the slots.

3. A louver rotating mechanism according to claim 2 wherein the gate system includes a plurality of respective gates for opening and closing respective slots.

4. A louver rotating mechanism according to claim 3 wherein each respective gate is movable relative to the guiding track between a first position in which the respective slot is closed and a second position in which the respective slot is open.

5. A louver rotating mechanism according to claim 4 wherein the gate system includes a gate slider having a plurality of the respective gates for opening and closing respective slots, the gate slider being movable relative to the guiding track between the first position in which the slots are closed and the second position in which the slots are open.

6. A louver rotating mechanism according to claim 5 wherein the gate slider is movable in the length direction of the guiding track.

7. A louver rotating mechanism according to claim 6 wherein the slot and gate system further includes a coupler block movable along the guiding track to operate the gate system to open the slots.

8. A louver rotating mechanism according to claim 7 wherein:
the plurality of louver holders are arranged as an array along the guiding track and include an extended-most louver holder at the distal end of the array; and
the extended-most louver holder is arranged to abut and move the coupling block to operate the gate system.

9. A louver rotating mechanism according to claim 8 wherein translatory movement of the coupling block in the length direction of the guiding track is arranged to move the gate slider in the same direction.

10. A louver rotating mechanism according to claim 9 wherein the gate slider defines a plurality of cavities spaced in accordance with the successive transverse slots and movable between the first position in which none of the cavities is in register with a transverse slot and the second position in which all of the cavities are in register with a respective transverse slot.

11. A louver rotating mechanism according to claim 5 wherein the gate slider is movable transversely to the length of the guiding track.

12. A louver rotating mechanism according to claim 11 wherein the gate slider includes a plurality of gate recesses which confront respective slots and the gate recesses include respective barrier wall portions for blocking access to the respective slots.

13. A louver rotating mechanism according to claim 12 wherein the gate system includes a longitudinal slider moveable in the length direction of the guiding track and the gate slider is connected to the longitudinal slider such that movement of the longitudinal slider in the length direction of the guiding track is converted into transverse movement of the gate slider.

14. A louver rotating mechanism according to claim 13 wherein the gate slider connects with the longitudinal slider by sliding pins engaging in conversion tracks having respective slanted end portions.

15. A louver rotating mechanism according to claim 12 wherein the gate slider is movable transversely between a blocking position in which the slots are closed and an access position in which the slots are open.

16. A louver rotating mechanism according to claim 15 wherein the gate recesses include respective transverse recess parts extending behind the respective barrier wall portions and blocked by the respective barrier wall portions when the gate recesses are in the blocking position.

17. A louver rotating mechanism according to claim 16 wherein the gate recesses further include respective longitudinal recess parts extending longitudinally from behind respective barrier wall portions such that, when the gate slider is in the access position, the respective barrier wall portions are positioned transversely outwardly from the slots so as to expose and provide access to the respective transverse recess parts via the respective longitudinal recess parts.

18. A louver rotating mechanism according to claim 17 wherein the slot and gate system further includes a coupler block moveable along the guiding track to operate the gate system to open the slots.

19. A louver rotating mechanism according to claim 18 wherein:
the plurality of louver holders are arranged as an array along the guide track and include an extended most louver holder at the distal end of the array; and
the extended most louver holder is arranged to abut and move the coupling block to operate the gate system.

20. A louver rotating mechanism according to claim 19 wherein translatory movement of the coupling block in the length direction of the guiding track is arranged to move the longitudinal slider in the same direction.

21. A louver rotating mechanism according to claim 20 wherein the guiding track includes a re-entrant flange defining said transverse slots.

22. A louver rotating mechanism according to claim 2 wherein the slot and gate system includes:
a guide wall extending alongside the guiding track with a plurality of spaced apart openings defined in the guide wall; and
a plurality of respective slider units arranged in respective openings; wherein
the plurality of slots are provided in respective slider units.

23. A louver rotating mechanism according to claim 22 wherein the slider units are movable transversely between a blocking position in which the slots are closed and an access position in which the slots are open.

24. A louver rotating mechanism according to claim 23 wherein each slider unit includes a respective barrier wall portion arranged to block access to a respective opening when the respective slider unit is in the blocking position.

25. A louver rotating mechanism according to claim 24 wherein the slots are provided behind the respective barrier wall portions such that, when the slider units are in the access position, the respective barrier wall portions are positioned transversely outwardly from the guide wall so as to expose and provide access to the respective slots for the tilt arms.

26. A louver rotating mechanism according to claim 25 wherein the slider units are movable in the length direction of the guide track whilst moving transversely such that, in the access position, the respective barrier wall portions are displaced longitudinally with respect to the openings so as to expose the respective slots

27. A louver rotating mechanism according to claim 26 wherein the slider units are connected relative to the guide wall by sliding pins engaging in conversion tracks having respective slanted portions.

28. A louver rotating mechanism according to claim 21 wherein the slider units are provided on the gate slider and the gate slider is movable transversely to the length of the guiding track.

29. A louver rotating mechanism according to claim 28 wherein the slot and gate system further includes a coupler block movable along the guiding track to operate the gate system to open the slots.

30. A louver rotating mechanism according to claim 29 wherein:
the plurality of louver holders are arranged as an array along the guiding track and include an extended-most louver holder at the distal end of the array; and
the extended-most louver holder is arranged to abut and move the coupling block to operate the gate system.

31. A louver rotating mechanism according to claim claim 30 wherein translatory movement of the coupling block in the length direction of the guiding track is arranged to move the gate slider in the same direction.

32. A louver rotating mechanism according to claim 31 wherein a detachable attachment is provided between the gate slider and the coupling block for attaching the gate slider and the coupling block, the detachable attachment being arranged to detach the gate slider from the coupling block when the slider units are in the access position so as to allow additional longitudinal movement of the coupling block.

33. A louver rotating mechanism according to claim 32 wherein the louver holders are biased towards the closed position.

34. A louver rotating mechanism according to claim 33 wherein the louver holders are biased towards the closed position by one or more of a torsion spring and gravity.

35. A louver rotating mechanism according to claim 34 wherein each tilt arm includes a respective follower pin engageable in a respective slot.

36. A louver rotating mechanism according to claim 35 further including a plurality of louver carrier trucks movable along the guiding track wherein each louver holder is pivotably journalled on a respective louver carrier truck.
